(19) United States
(12) Patent Application Publication
(10) Pub. No.: US 2025/0044637 A1
(43) Pub. Date: Feb. 6, 2025

(54) DISPLAY DEVICE

(71) Applicant: Sharp Display Technology Corporation, Kameyama City (JP)

(72) Inventors: Hisashi WATANABE, Kameyama City (JP); Hirotoshi YASUNAGA, Kameyama City (JP); Masato KURAHASHI, Kyoto-shi (JP)

(21) Appl. No.: 18/754,636

(22) Filed: Jun. 26, 2024

(30) Foreign Application Priority Data
Aug. 4, 2023 (JP) 2023-127666

(51) Int. Cl. G02F 1/1335; G02F 1/1343

(52) U.S. Cl. CPC G02F 1/133536; G02F 1/134309; G02F 2201/38

(57) ABSTRACT

Provided is a display device with reduced interface reflection and high luminance. The display device includes: a display panel; and a front surface plate disposed closer to an observer side than the display panel is. The display panel in a plan view includes a display region and a frame region surrounding the display region. The front surface plate in a plan view includes a design layer that overlaps the display region. The front surface plate transmits at least part of light incident from the display panel and reflects at least part of light incident from the observer side. A transmittance of a region of the front surface plate overlaps the display region being 50% or higher. The front surface plate and the display panel are attached to each other with an optical adhesive layer. A refractive index of the optical adhesive layer is 1.4 or higher and 1.6 or lower.

### CROSS-REFERENCE TO RELATED APPLICATIONS

The present application claims priority under 35 U.S.C. § 119 to Japanese Patent Application No. 2023-127666 filed on Aug. 4, 2023, the contents of which are incorporated herein by reference in their entirety.

### BACKGROUND OF THE INVENTION

### Field of the Invention

The present disclosure relates to display devices.

### Description of Related Art

There are display devices that display a desired image when their display screen is turned on. Studies to harmonize the display panel of such a display device with the surrounding components, casing, and the like have been made to make the display panel inconspicuous when the display panel is turned off, for improvement of the designability of the display device.

For example, JP 5725581 B discloses a printed matter including: a base film; a first color pattern layer composed of first color dots and provided on the base film; a second color pattern layer composed of second color dots and provided on the first color pattern layer; and a third color pattern layer composed of third color dots and provided on the second color pattern layer, wherein each of the first color dots includes a binder for first color and first color pigment chips dispersed inside the binder for first color, each of the second color dots includes a binder for second color and second color pigment chips dispersed inside the binder for second color, each of the third color dots includes a binder for third color and third color pigment chips dispersed inside the binder for third color, and a group of the first color pigment chips, a group of the second color pigment chips, and a group of the third color pigment chips are each one of a red interference pigment, a green interference pigment, and a blue interference pigment.

### BRIEF SUMMARY OF THE INVENTION

Reflective pigments as disclosed in JP 5725581 B have a property of reflecting only ambient light components having specific wavelengths. When the pattern layer is formed on a transparent base material, ambient light transmitted through a reflective pigment undergoes interface reflection at the interface between the transparent base material and the air. The observer sees mixture of light reflected by the reflective pigment and light having undergone interface reflection by the transparent base material (hereinafter, also referred to as interface-reflected light). Since interface reflection causes incident ambient light to be reflected with almost no change in color, the color of the interface-reflected light includes the complementary color of the color of light reflected by the reflective pigment. Thus, when light reflected by the reflective pigment and the interface-reflected light are mixed, the reflective display sometimes appears whitish.

Conventional printed matters with a pattern layer containing interference pigments includes a smoke printed layer on the back surface side of the pattern layer in order to provide vivid reflective display of the pattern layer. FIG. 11 of JP 5725581 B shows the light source 3 disposed behind the back surface side (the side opposite to the point of view) of the printed matter. The printed matter includes the transmissive smoke printed layer 27 formed on the back surface side of the pattern layer composed of dots containing interference pigments.

Absorbing ambient light transmitted through the reflective pigments, the smoke layer reduces interface reflection at the transparent base material-air interface, making the reflective display appear vivid. A smoke layer, however, undesirably absorbs also light to be transmitted therethrough, which is light emitted from the display panel side toward the observer side, to decrease the luminance during transmissive display in some cases. To increase the luminance during transmissive display, the luminance of components such as the backlight needs to be increased, which however involves issues such as an increase in power consumption and heat buildup. The above technique thus leaves room for improvement to provide both vivid reflective display and high-luminance transmissive display.

In response to the above issues, an object of the present invention is to provide a display device with reduced interface reflection and high luminance.

(1) One embodiment of the present invention is directed to a display device including: a display panel; and a front surface plate disposed closer to an observer side than the display panel is, the display panel in a plan view including a display region and a frame region surrounding the display region, the front surface plate in a plan view including a design layer that overlaps the display region, the front surface plate transmitting at least part of light incident from the display panel and reflecting at least part of light incident from the observer side, a transmittance of a region of the front surface plate overlapping the display region being 50% or higher, the front surface plate and the display panel being attached to each other with an optical adhesive layer, a refractive index of the optical adhesive layer being 1.4 or higher and 1.6 or lower.

(2) In an embodiment of the present invention, the display device includes the structure (1), and the display panel includes a circular polarizer in its front surface plate side.

(3) In an embodiment of the present invention, the display device includes the structure (1) or (2), the display panel is a liquid crystal panel, and the liquid crystal panel includes a first substrate including a first electrode, a liquid crystal layer, and a second substrate including a second electrode in the stated order.

(4) In an embodiment of the present invention, the display device includes the structure (1) or (2), and the display panel is a self-luminous panel.

(5) In an embodiment of the present invention, the display device includes any one of the structures (1) to (4), the front surface plate in a plan view includes a first region overlapping the display region of the display panel and a second region surrounding the first region, and a reflectance of the second region is 6% or higher and 12% or lower.

The present invention can provide a display device with reduced interface reflection and high luminance.

### BRIEF DESCRIPTION OF THE DRAWINGS

FIG. 1 is a schematic plan view showing an example of a display device according to Embodiment 1.

FIG. 2 is a schematic cross-sectional view taken along line X1-X2 in FIG. 1.

FIG. 3 is a schematic cross-sectional view showing a modified example of Embodiment 1.

FIG. 4 is a schematic cross-sectional view showing another modified example of Embodiment 1.

FIG. 5 is a schematic cross-sectional view showing part of the configuration of the display device according to Embodiment 1 and a display method thereof.

FIG. 6 is a schematic cross-sectional view showing an example of a display device according to Embodiment 2.

FIG. 7 is a schematic cross-sectional view showing an example of a display device according to Embodiment 3.

FIG. 8 is a schematic plan view of a display device, showing the boundary between the display region and the frame region of a liquid crystal panel superimposed with the outer edge of a black frame layer.

FIG. 9 is a schematic plan view showing an example of a black frame layer included in a front surface plate in Embodiment 4.

FIG. 10 is a schematic plan view of a first example, with part of the second region in FIG. 9 being enlarged.

FIG. 11 is a schematic plan view of a second example, with part of the second region in FIG. 9 being enlarged.

FIG. 12 is a schematic plan view of a third example, with part of the second region in FIG. 9 being enlarged.

FIG. 13 is a reference diagram of a display panel, illustrating a decrease in black level during transmissive display.

FIG. 14 is a reference diagram of a display device with the display panel in FIG. 13 being overlaid with a front surface plate.

FIG. 15 is a schematic plan view showing an example of a direct-lit backlight.

FIG. 16 is a schematic plan view showing an example of an edge-lit backlight.

FIG. 17 is a graph showing an example of luminance of the third region (iii) and the fourth region (iv) in each of the backlights shown in FIG. 15 and FIG. 16.

FIG. 18 is a schematic cross-sectional view illustrating part of the configuration of a display device according to Comparative Example 1 and a display method thereof.

FIG. 19 is a schematic cross-sectional view illustrating part of the configuration of a display device according to Comparative Example 2 and a display method thereof.

FIG. 20 is a graph showing the interface reflectance when light enters a medium with a refractive index of 1 from a medium with a refractive index of 1.5.

### DETAILED DESCRIPTION OF THE INVENTION

Hereinafter, the present invention is described in more detail based on embodiments with reference to the drawings. The present invention is not limited to the following embodiments. In the following description, components having the same or similar functions in different drawings are commonly provided with the same reference sign so as to appropriately avoid repetition of description. The structures in the present invention may be combined as appropriate without departing from the gist of the present invention.

Herein, the expression that two directions are orthogonal to each other means that the angle formed between the two directions falls preferably within the range of 90°±3°, more preferably within the range of 90°±1°, still more preferably within the range of 90°±0.5°. The expression that two directions are parallel to each other means that the angle formed between the two directions falls preferably within the range of 0°±3°, more preferably within the range of 0°±1°, still more preferably within the range of 0°±0.5°.

Herein, the “observer side” means the surface to be observed by the observer and is also referred to as the “front surface side”. The “back surface side” means the surface opposite to the observer side.

### Embodiment 1

A display device according to Embodiment 1 includes: a display panel; and a front surface plate disposed closer to an observer side than the display panel is. The display panel in a plan view includes a display region and a frame region surrounding the display region. The front surface plate in a plan view includes a design layer that overlaps the display region. The front surface plate transmits at least part of light incident from the display panel and reflects at least part of light incident from the observer side. A transmittance of a region of the front surface plate overlapping the display region is 50% or higher. The front surface plate and the display panel are attached to each other with an optical adhesive layer. A refractive index of the optical adhesive layer is 1.4 or higher and 1.6 or lower.

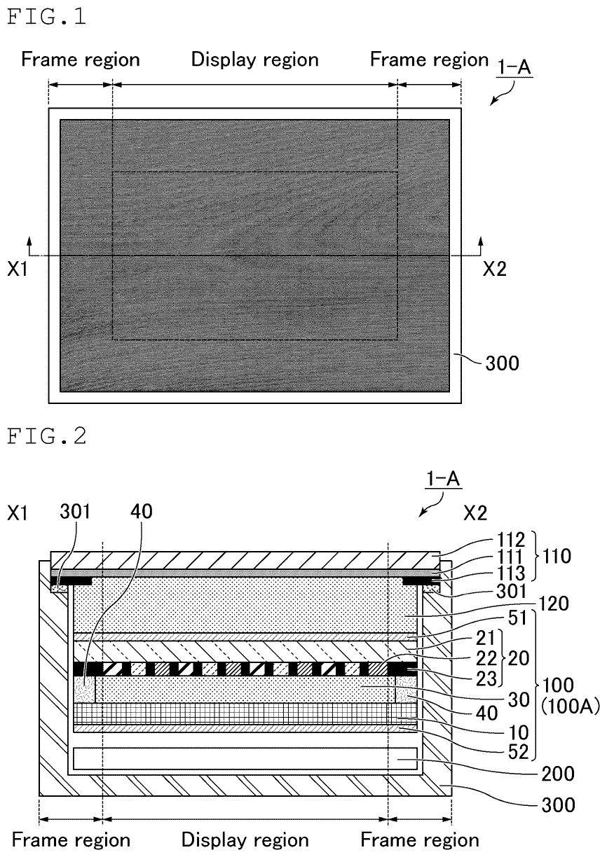

FIG. 1 is a schematic plan view showing an example of a display device according to Embodiment 1. FIG. 2 is a schematic cross-sectional view taken along line X1-X2 in FIG. 1. As shown in FIG. 2, a display device 1-A according to Embodiment 1 includes a display panel 100 and a front surface plate 110 disposed closer to the observer side than the display panel 100 is.

### (Display Panel)

As shown in FIG. 1, the display panel 100 (100A) in a plan view includes a display region and a frame region surrounding the display region. In FIG. 1, the dotted line indicates the boundary between the display region and the frame region of the display panel. An inner side edge of a black matrix 23 located toward the center of the display panel shown in FIG. 2 (an outline of the black matrix 23 positioned closer to the center of the display panel) defines the boundary between the display region and the frame region. The display region is a region that includes pixels and displays the desired image or the like during transmissive display. The frame region is a region that overlaps the casing and the bezel and has no involvement in transmissive display.

In Embodiment 1, a configuration is described in which a liquid crystal panel 100A is used as the display panel 100 and a backlight 200 is disposed behind the back surface of the liquid crystal panel 100A. The display panel 100 may also be a self-luminous panel such as an LED panel including a light emitting diode (LED). Herein, a liquid crystal panel and a self-luminous panel are each simply referred to as a display panel 100 when no distinction is made therebetween.

### (Liquid Crystal Panel)

The liquid crystal panel 100A includes a pair of substrates and a liquid crystal layer sandwiched between the pair of substrates. The pair of substrates may be a pair of a TFT substrate 10 including switching elements such as thin film transistors (TFTs) and a color filter (CF) substrate 20 including color filters. The TFT substrate 10 and the CF substrate 20 are attached to each other with a sealing material 40. A liquid crystal layer 30 is sealed between the substrates.

Although not shown, an example of the configuration of the TFT substrate 10 is one including, on a supporting substrate, gate lines and source lines crossing the gate lines, TFTs placed at or near the intersections of the gate lines and the source lines, and pixel electrodes electrically connected to the TFTs. Each region surrounded by gate lines and source lines is a pixel.

The pixel electrodes and the later-described counter electrode may be transparent electrodes, and can be made of, for example, a transparent conductive material such as indium tin oxide (ITO), indium zinc oxide (IZO), zinc oxide (ZnO), or tin oxide (SnO), or an alloy of any of these materials.

The color filter substrate 20, for example, may include on a supporting substrate 21 a color filter layer 22 and the black matrix 23. The color filter layer 22 may include red, green, and blue color filters. Each color filter overlaps a pixel of the TFT substrate. The desired color can be expressed by mixing colors while controlling the amounts of lights transmitted through the color filters of different colors.

The black matrix 23 in a plan view may be disposed to partition the color filters. The color filters and the black matrix are not limited and may each be one known in the field of liquid crystal panels.

The supporting substrates used in the TFT substrate 10 and the CF substrate 20 are preferably transparent substrates, such as glass substrates or plastic substrates.

The display mode of the liquid crystal panel may be the vertical electric field mode or the transverse electric field mode. Examples of the vertical electric field mode include the vertical alignment (VA) mode where with no voltage applied, the liquid crystal molecules in the liquid crystal layer are aligned substantially vertically to the substrate surfaces. Examples of the transverse electric field mode include the fringe field switching (FFS) mode and the in-plane-switching (IPS) mode where with no voltage applied, the liquid crystal molecules in the liquid crystal layer are aligned substantially horizontally to the substrate surfaces. The state with no voltage applied incudes cases where voltage lower than the threshold for the liquid crystal molecules is applied to the liquid crystal layer.

The expression “substantially horizontally” means that the tilt angle is 0° or greater and 10° or smaller, preferably 0° or greater and 5° or smaller, more preferably 0° or greater and 2° or smaller. The expression “substantially vertically” means that the tilt angle is 83° or greater and 90° or smaller, preferably 85° or greater and 90° or smaller, more preferably 87.5° or greater and 88.0° or smaller.

The liquid crystal layer 30 controls the amount of light transmitted therethrough using its liquid crystal molecules whose alignment changes according to the electric field generated inside the liquid crystal layer 30 in response to the voltage applied between the pixel electrode and the counter electrode. In the vertical electric field mode, the counter electrode is disposed in the TFT substrate while in the transverse electric field mode, the counter electrode is disposed in the CF substrate.

The anisotropy of dielectric constant (Δε), defined by the following formula (L), of the liquid crystal molecules may be positive or negative.

Δε=(dielectric constant in long axis direction)−(dielectric constant in short axis direction) (L)

As shown in FIG. 2, the liquid crystal panel 100A may include a first linear polarizer 51 disposed closer to the front surface side and may include a second linear polarizer 52 disposed closer to the back surface side. The first and second linear polarizers 51 and 52 are polarizers each transmitting only light with a specific polarization direction. The linear polarizers may each be an absorptive linear polarizer having a transmission axis transmitting only light with a specific polarization direction and an absorption axis orthogonal to the transmission axis. The first and second linear polarizers 51 and 52 are preferably arranged with their transmission axes being orthogonal to each other. The first and second linear polarizers 51 and 52 can be known polarizers, such as, for example, “TEG1465DU” available from Nitto Denko Corporation.

Although not shown, the first linear polarizer 51 may be attached with a transparent adhesive to the surface of the CF substrate 20 opposite to the liquid crystal layer 30, and the second linear polarizer 52 may be attached with a transparent adhesive to the surface of the TFT substrate 10 opposite to the liquid crystal layer 30.

Although not shown, alignment films controlling the alignment azimuth of the liquid crystal molecules with no voltage applied may be disposed, one between the TFT substrate 10 and the liquid crystal layer 30 and one between the CF substrate 20 and the liquid crystal layer 30. The alignment film can be made of a material commonly used in the field of liquid crystal panels, such as a polymer having a polyimide, polyamic acid, or polysiloxane main chain structure.

### (Front Surface Plate)

The front surface plate 110 is a component that transmits at least part of light incident from the display panel 100 and reflects at least part of light incident from the observer side.

The transmittance of a region of the front surface plate 110 overlapping the display region of the display panel 100 is 50% or higher. The display device according to Embodiment 1 including the front surface plate 110 with a transmittance of 50% or higher can provide transmissive display while maintaining the luminance of the display device high. When the transmittance of the front surface plate 110 is lower than 50%, the luminance of the display device may significantly decrease to make the displayed image difficult to see in a bright environment. In order to make the displayed image easier to see, the luminance of the backlight needs to be high to increase the luminance of the display device, which leads to an increase in power consumption by the backlight. The transmittance of the front surface plate 110 is more preferably 70% or higher. The upper limit of the transmittance of the front surface plate 110 is, for example, 90%. Herein, the transmittance refers to the total light transmittance and is measured by a method in conformity with JIS K 7361-1. The total light transmittance can be measured, for example, with a device such as a haze meter NDH2000 available form Nippon Denshoku Industries Co., Ltd.

Conventionally, for example, in the printed matter disclosed in JP 5725581 B, a smoke layer such as a transmissive smoke printed layer is disposed on the back surface side in order to reduce or prevent interface reflection. A smoke layer is, for example, a layer with a low transmittance formed on a surface of a transparent substrate by a technique such as solid printing. An example thereof is a smoke layer with a transmittance of 70% or lower. When a smoke layer is disposed on the back surface side of the front surface plate, the transmittance of the front surface plate is considered to be lower than 50%. In other words, in the display device according to the present embodiment, preferably, no smoke layer is disposed in a region of the front surface plate 110 overlapping the display region of the display panel 100.

In the display region of the display panel, the transmittance between the observer side surface of the display panel 100 (the observer side surface of the first linear polarizer 51 in FIG. 2) and the observer side surface of the front surface plate (the surface of the transparent base material 112 in FIG. 2) is preferably 50% or higher, more preferably 70% or higher.

The front surface plate 110 in a plan view includes a design layer 111 overlapping the display region of the display panel 100. The design layer 111 is a layer expressing a specific pattern or the like. The pattern or the like is perceived by the observer in the reflective display state. Non-limiting examples of the specific pattern include geometric patterns with designability, wood grain patterns, specific character strings, and company logos.

The design layer 111 preferably includes a reflective pigment. The reflective pigment is a pigment that reflects ambient light with specific wavelengths to the observer side and that causes the observer to perceive the specific colors corresponding to the wavelengths of light to be reflected. The specific wavelengths are those of light in the visible spectrum (380 nm to 780 nm). The design layer 111 may contain reflective pigments of multiple colors to cause the observer to perceive the desired color through additive color mixing of lights reflected by the reflective pigments of multiple colors.

With the design layer 111 containing a reflective pigment, the front surface plate 110 can reflect at least part of light incident from the observer side. The front surface plate 110 can transmit at least part of light incident from the display panel 100 to the observer side since there are gaps between the particles of the pigment in the design layer 111.

Examples of the reflective pigment include interference pigments and metallic pigments.

Interference pigments are also called pearl pigments, and may reflect light with specific wavelengths and transmit light with wavelengths other than the specific wavelengths. Examples of the interference pigments include those including a base material and a coating layer covering the base material.

The base material can be flakes transparent to light with wavelengths in the visible spectrum. The coating layer can be a metal oxide film having a higher refractive index than the flakes. The interference pigment may be dispersed in a binder resin to be applied to a base film. Changing the thickness of the coating layer allows adjustment of the color of interference light to be perceived by the observer. Examples of the interference pigments include those mentioned in JP 5725581 B (registration gazette of JP 5725581 B).

When the design layer 111 contains an interference pigment, part of ambient light is reflected at the interface between the air layer and the coating layer and at the interface between the coating layer and the base material. Different part of the ambient light is transmitted through the base material and reflected on the surface of the base film. The observer perceives the combination of these reflected lights as interference light of a pearly specific color including the color of the base film.

The metallic pigments may reflect light having specific wavelengths and absorb light having wavelengths other than the specific wavelengths. Examples of the metallic pigments include metallic strips coated with a pigment, and the pigment may be coated with a polymer such as an acrylic resin. Examples of the metallic pigments include “FRIEND COLOR®” available from Toyo Aluminium K.K.

The metallic strips are preferably those that reflect visible light, and examples include aluminum, nickel, titanium, stainless steel, and alloys of any of these metals.

The pigment used to coat the metallic strips may be an organic pigment or an inorganic pigment, but is preferably an organic pigment. Examples of the organic pigment include phthalocyanine, halogenated phthalocyanine, quinacridone, diketopyrrolopyrrole, isoindolinone, azomethine metal complexes, indanthrone, perylene, perynone, anthraquinone, dioxazine, benzoimidazolone, condensed azo, triphenylmethane, quinophthalone, and anthrapyrimidine. Examples of the inorganic pigment include titanium oxide, iron oxide, carbon black, and bismuth vanadate.

As shown in FIG. 2, the design layer 111 may be disposed on the back surface side of the transparent base material 112. Although not shown, the design layer 111 may be disposed on the front surface side of the transparent base material 112. The design layer 111 only needs to be disposed on part of the surface of the transparent base material 112 such that the specific pattern or the like can be expressed. The design layer 111 may not be disposed on the entire surface of the transparent base material 112.

The transparent base material 112 is suitably a component that transmits light, and may be used as a printing base material of the design layer 111. The transparent base material 112 preferably has a high transmittance in order to maintain the luminance of the display device high. For example, the transmittance is preferably 90% or higher. To reduce or prevent blurriness of the displayed image, the transparent base material 112 preferably has a haze of 10% or lower. The haze can be measured by a method in conformity with JIS K 7136, for example, with a device such as a turbidity meter “Haze Meter NDH2000” available form Nippon Denshoku Industries Co., Ltd.

The transparent base material 112 can be, for example, a glass plate or a resin plate such as an acrylic plate or a polycarbonate plate. The transparent base material 112 may have a flat surface or a curved surface.

The design layer 111 may be obtained by, for example, printing on the surface of the transparent base material 112 by a printing method such as gravure printing, screen printing, or inkjet printing.

When being disposed on the back surface side of the transparent base material 112 as shown in FIG. 2, the design layer 111 can be prevented from being scratched. Although the transparent base material 112 creates senses of depth and luster when disposed on the observer side of the design layer 111, the senses of depth and luster may spoil the texture of the design layer 111 in some cases depending on the pattern of the design layer 111. To express the texture of the design layer 111 more vibrantly, the design layer 111 is preferably disposed on the front surface side of the transparent base material 112. On the other hand, when the design layer 111 is disposed on the front surface side of the transparent base material 112, the design layer 111 is more vulnerable to scratches. Thus, a hard coat layer (not shown) may further be disposed on the front surface side of the design layer 111.

The hard coat layer is preferably one with high transparency and high scratch resistance. Examples include coating layers such as acrylic resin layers and epoxy resin layers. The transmittance of the hard coat layer is preferably 90% or higher, for example.

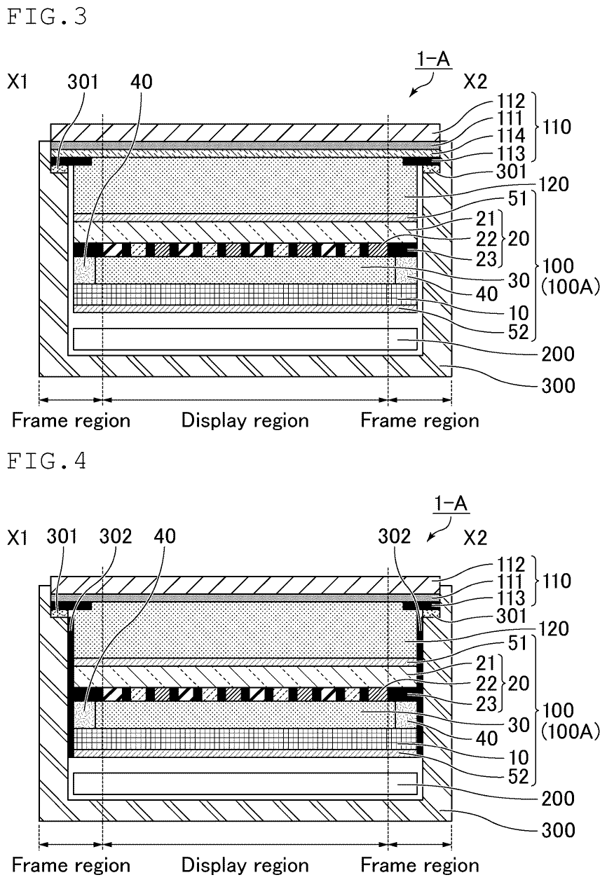

FIG. 3 is a schematic cross-sectional view showing a modified example of Embodiment 1. As shown in FIG. 3, the front surface plate 110 may include a planarization layer 114 on the back surface side (display panel 100 side) of the design layer 111. In a case where the design layer 111 is a printed layer obtained by, for example, screen printing, there may be irregularities of about 5 to 10 μm, depending on the pattern of the design layer 111. If the printed layer has irregularities, fine air bubbles may enter between the front surface plate 110 and an optical adhesive layer 120, so that visibility of reflective display may be decreased. When the planarization layer 114 is disposed to planarize the surface of the front surface plate 110 opposite to the optical adhesive layer 120 (for example, the planarized surface has irregularities of 3 μm or less), air bubbles are less likely to enter the irregularities, so that the reflective display can be made more vivid.

The planarization layer 114 is preferably a transparent resin layer, and may be made of a transparent resin such as an acrylic resin or an epoxy resin. The planarization layer 114 can be formed by a method such as printing of the transparent resin. The planarization layer 114 preferably has a transmittance of 90% or higher.

As shown in FIG. 2, the front surface plate 110 may include a black frame layer 113 on the back surface side of the design layer 111. The black frame layer 113 is a light blocking layer, and is preferably disposed in the region overlapping the frame region of the display panel 100 in a plan view. The transparent base material 112 is preferably larger than the display region of the display panel 100, and the black frame layer 113 may be disposed in the region (frame region) where the transparent base material 112 protrudes from the display region. With the black frame layer 113 disposed, stray light from the display panel 100 side can be blocked, so that the design layer 111 can appear more vivid. In addition, with the black frame layer 113 disposed, the bezel, the frame, and the like can be prevented from being seen through by the observer. The outer edge of the black matrix 23 of the display panel 100 and the outer edge of the black frame layer 113 may or may not coincide with each other.

The material of the black frame layer 113 may be a material similar to the material of the black matrix 23, and the black frame layer 113 may be formed using a material such as a black pigment by a printing method such as screen printing. The black frame layer 113 may be formed by solid printing to make the transmittance substantially uniform, or may be formed by gradation printing as described below. Black tape may also be used.

### (Optical Adhesive Layer)

The optical adhesive layer 120 is a transparent pressure-sensitive adhesive layer or adhesive layer used to attach optical components to each other, and may be a sheet-shaped pressure-sensitive adhesive layer or may be a cured liquid adhesive.

The front surface plate 110 and the display panel 100 are attached to each other with the optical adhesive layer 120. In other words, no air layer is interposed between the front surface plate 110 including the design layer 111 and the display panel 100. The expression “the front surface plate 110 and the display panel 100 are attached to each other with the optical adhesive layer 120” means that there is no air layer between the front surface plate 110 including the design layer 111 and the display panel 100. The front surface plate 110 and the display panel 100 may therefore each be in contact with the optical adhesive layer 120, or there may be a component other than the optical adhesive layer 120, such as a transparent base material, between the front surface plate 110 and the display panel 100. In other words, the front surface plate 110 and the display panel 100 are integrated into one component with the optical adhesive layer 120.

When an air layer is not interposed between the front surface plate 110 and the display panel 100, reflection at the interface with the air is eliminated, and the internal reflectance of the entire display device can be reduced. When the internal reflectance of the entire display device is reduced, the colors of the pattern or the like of the design layer 111 does not appear whitish, so that the reflective display can be perceived in clear and vivid colors. The display device 1-A according to Embodiment 1 can achieve vivid reflective display without a semi-transmissive smoke layer such as the transmissive smoke printed layer in JP 5725581 B. Furthermore, since the display device according to the embodiment does not include a smoke layer, the luminance during transmissive display is not reduced, and it is possible to achieve both vivid reflective display and high-luminance transmissive display.

The back surface side of the front surface plate 110 and the front surface side of the display panel 100 are each preferably in contact with the optical adhesive layer 120. The optical adhesive layer 120 may include a single layer or a stack of optical adhesive layers, but preferably includes a single layer.

The optical adhesive layer 120 has a refractive index of 1.4 or higher and 1.6 or lower. Preferably, the refractive index of the optical adhesive layer 120 is at least higher than 1 (refractive index of air at 0° C. and 1 atm) and higher than refractive indices of the transparent base material 112 and the front surface side polarizer (in FIG. 2, the first linear polarizer 51) of the display panel. When the refractive index of the optical adhesive layer 120 is set to 1.4 or higher and 1.6 or lower, the transmitted light having passed through the design layer 111 can be prevented from returning to the observer side through interface reflection. There is a complementary color relationship between the interface-reflected light of the transmitted light having passed through the design layer 111 and the light reflected by the design layer 111. Thus, reducing or preventing the interface-reflected light enables provision of more vivid reflective display.

The transmittance of the optical adhesive layer 120 is preferably 90% or higher, and the haze of the optical adhesive layer 120 is preferably 10% or lower. Examples of the optical adhesive layer 120 include “LUCIACS CS986” series available from Nitto Denko Corporation.

When the thickness of the optical adhesive layer 120 is made sufficiently greater than thicknesses of the components such as the design layer 111 and the black frame layer 113, entry of air bubbles can be prevented when the display panel 100 and the front surface plate 110 are attached to each other. The thickness of the optical adhesive layer 120 is preferably 10 times or more the thickness of the black frame layer 113. For example, when the thickness of the black frame layer 113 is 20 μm, the thickness of the optical adhesive layer 120 is preferably 200 μm or more.

In addition, when the design layer 111 is disposed in the back surface side of the front surface plate 110, the thickness of the optical adhesive layer 120 is preferably 200 μm or more. When the thickness of the optical adhesive layer 120 is 200 μm or more, the design layer 111 and the display panel can be attached to each other without entry of air bubbles in between even when the design layer 111 has irregularities of 5 to 10 μm.

### (Backlight)

In Embodiment 1, the backlight 200 is disposed behind the back surface side of the liquid crystal panel 100A. The backlight 200 can be a known one and may be, for example, an edge-lit backlight including light sources on the end surfaces of a light guide plate or a direct-lit backlight including light sources on its surface and increasing the uniformity of light using a diffuser, for example.

### (Casing)

The display device according to Embodiment 1 may further include a casing 300 that houses the display panel 100 and the front surface plate 110. Double-sided tape 301 may be disposed on the back surface side of the front surface plate 110 overlapping the frame region (the back surface side of the black frame layer 113 in FIG. 2) to fix the front surface plate 110 to the casing 300. The casing 300 may include inside, for example, a circuit substrate (not shown) on which drive circuits that drive the display panel 100 and the backlight 200 are formed. The casing 300 may be any casing that can house the display panel 100 and the front surface plate 110 and may be made of a metal or resin. The shape of the casing 300 is not limited to the shape shown in FIG. 2.

FIG. 4 is a schematic cross-sectional view showing another modified example of Embodiment 1. As shown in FIG. 4, a black layer 302, which is a light blocking component, may be disposed on the side surfaces of the display panel 100 and/or the inner surfaces (inner walls) of the casing 300. When the display device 1-A is viewed from an oblique direction, the display region may appear slightly bright in some cases due to stray light from the backlight 200. Such stray light can be absorbed by the black layer 302.

The black layer 302 may be formed by applying a black pigment, or may be formed by attaching black-colored light blocking tape or a cushion material such as a black-colored sponge. In order to obtain the effect of protecting the display device from impact, the cushion material is preferably disposed.

### <Description of Display Method>

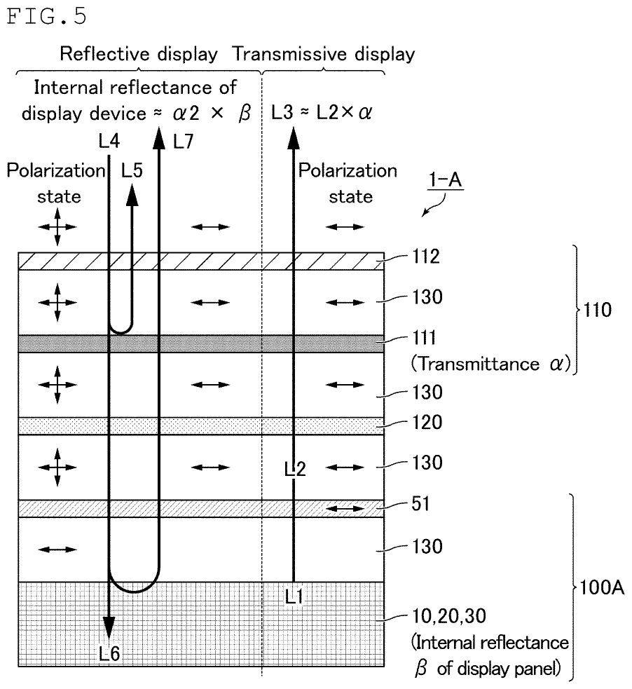

The following shows the display method of the display device according to Embodiment 1 with reference to FIG. 5. FIG. 5 is a schematic cross-sectional view showing part of the configuration of the display device according to Embodiment 1 and a display method thereof. In FIG. 5, a double-headed arrow pointing opposite directions and a pair of orthogonal double-headed arrows represent a polarization state of light; the double-headed arrow pointing opposite directions represents linearly polarized light vibrating in the opposite directions, and the pair of orthogonal double-headed arrows represents unpolarized light. The following shows an example in which the display panel is a liquid crystal panel. Although the components are attached with adhesive layers 130 in the example, no adhesive layer 130 may be used as long as the components are in close contact with each other such that no air layer is present between the components.

The display device according to the embodiment can provide reflective display and transmissive display. Herein, reflective display means a display method that uses reflection of light (ambient light) incident on the display device from the observer side to cause the observer to perceive the pattern of the design layer. Herein, transmissive display means a display method that causes light (display light) emitted from the display panel side to be transmitted through the front surface plate to the observer side, thus causing the observer to perceive an image or the like displayed on the display panel.

When the display panel is a liquid crystal panel, the transmissive display can be provided by creating a state where the liquid crystal panel is in the white display state and the backlight is on. The reflective display can be provided by creating a state where the liquid crystal panel is in the black display state and the backlight is on or off. The reflective display can also be provided by creating a state where the liquid crystal panel in the white display state and, for example, the backlight is off or the backlight illumination is reduced to an extent that allows the observer to perceive the pattern or the like of the design layer with reflected light.

The black display state refers to a state where the alignment azimuth of the liquid crystal molecules is substantially parallel to the transmission axis of the first linear polarizer 51 or the second linear polarizer 52. The white display state refers to a state where the alignment azimuth of the liquid crystal molecules forms an angle with the transmission axis of the first linear polarizer 51 or the second linear polarizer 52 to allow light, when emitted from the backlight, to be transmitted to the observer side. When the alignment azimuth of the liquid crystal molecules forms an angle of 45° with the transmission axis of the first linear polarizer 51 or the second linear polarizer 52, the transmittance is maximized, and the luminance of the liquid crystal panel can be maximized (full white state).

As shown in FIG. 5, during transmissive display, light (L1) emitted from the observer side of the liquid crystal panel 100A is transmitted through the first linear polarizer 51 in the observer side of the liquid crystal panel 100A. The light L1 is transmitted through the optical adhesive layer 120, the design layer 111, and the transparent base material 112, and is emitted toward the observer. When the luminance of the light after being emitted from the first linear polarizer 51 is denoted as a liquid crystal panel luminance (L2) and the transmittance of the design layer 111 is denoted as a, the luminance of light L3 emitted toward the observer (the luminance of the display device during transmissive display) is expressed as L2×α. Ambient light reflection, which is described later, also occurs during transmissive display; still, when the quantity of light emitted from the liquid crystal panel 100A side is sufficiently larger than the quantity of ambient light, it is difficult for the observer to perceive the pattern or the like of the design layer and thus the observer can perceive an image or the like displayed on the liquid crystal panel 100A.

Next, reflective display is described. As shown in FIG. 5, light incident on the display device from the observer side is denoted as ambient light L4. Part of L4 is transmitted through the transparent base material 112, reflected by the design layer 111, and emitted toward the observer (L5). Other part of L4 is transmitted through the design layer 111, the optical adhesive layer 120, and the first linear polarizer 51, and then incident on the liquid crystal panel 100A. Part of the light incident on the liquid crystal panel 100A is absorbed by the color filters and other internal components of the liquid crystal panel 100A (L6), and other part of the light is internally reflected by components such as conductive lines and electrodes constituting the liquid crystal panel 100A, transmitted again through the design layer 111, and emitted toward the observer (internally reflected light L7). Since the internally reflected light L7 passes through the design layer 111 twice, the internal reflectance of the display device is expressed as α²×β, where β represents the internal reflectance of the liquid crystal panel 100A.

The transmittance α of the design layer 111 varies depending on the pattern formed on the design layer 111. When the pattern is a wood grain, for example, the transmittance α is about 60% to 80%. The internal reflectance β of the liquid crystal panel 100A is a value obtained by subtracting a surface reflectance of the outermost surface of the liquid crystal panel 100A from the reflectance of the display region of the liquid crystal panel 100A. Although depending on the densities of the color filters, pixel design, and the like, the internal reflectance β is usually about 1% to 2%.

Since the display device according to the embodiment does not include a smoke layer, the luminance of the display device during transmissive display decreases by the transmittance α of the design layer 111, and there is almost no decrease in luminance due to the components other than the design layer 111. Therefore, it is not necessary to increase the luminance of the liquid crystal panel 100A using the backlight, which allows reduction in the power consumption and the heat buildup. In addition, since the liquid crystal panel 100A and the front surface plate 110 are attached to each other with the optical adhesive layer 120 to be an integrated component, the interface reflection does not occur between the liquid crystal panel 100A and the front surface plate 110. Thus, the internal reflectance of the display device during reflective display can be as low as a product (α²×β) of the internal reflectance β of the liquid crystal panel 100A and the amount corresponding to passing twice through the design layer 111 having the transmittance α. The transmittance α and the internal reflectance β can be measured using, for example, a spectrophotometer CM-5 available from Konica Minolta, Inc., for example.

### Embodiment 2

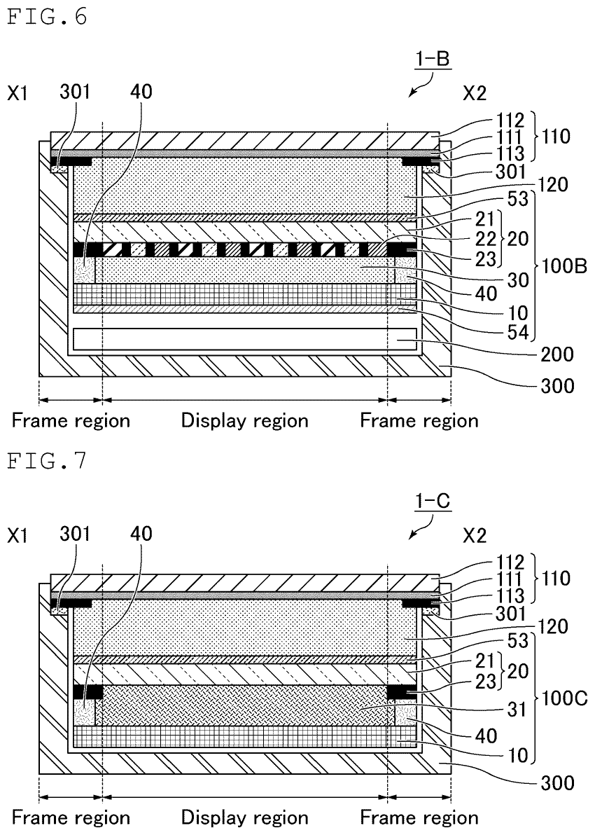

FIG. 6 is a schematic cross-sectional view showing an example of a display device according to Embodiment 2. As shown in FIG. 6, a display device 1-B according to Embodiment 2 uses a liquid crystal panel 100B as the display panel, and the display panel (liquid crystal panel 100B) includes a circular polarizer 53 in its front surface plate 110 side. With the circular polarizer 53 disposed in the front surface plate 110 side (front surface side) of the liquid crystal panel 100B, the reflection of the surface of the liquid crystal panel 100B can be substantially eliminated, so that the internal reflectance can be significantly reduced.

The circular polarizer 53 is a polarizing element that converts incident light to circularly polarized light. The liquid crystal panel 100B may also include a circular polarizer 54 in its back surface side. Examples of the circular polarizers 53 and 54 include a stack of a λ/4 waveplate and a linear polarizer. Preferably, the transmission axis of the linear polarizer in the circular polarizer 53 and the transmission axis of the linear polarizer in the circular polarizer 54 are orthogonal to each other.

The λ/4 waveplate may be any waveplate that provides a phase difference of a quarter of a wavelength to incident light having a wavelength λ. The λ/4 waveplate, for example, is a phase difference plate that provides an in-plane phase difference of a quarter of a wavelength (precisely, 137.5 nm), preferably an in-plane phase difference of 120 nm or more and 150 nm or less, to light with a wavelength of 550 nm.

The λ/4 waveplate may have a fast axis and a slow axis orthogonal to the fast axis. The fast axis of the λ/4 waveplate and the transmission axis of the third linear polarizer may form an angle of substantially 45°. Herein, an angle of substantially 45° is an angle falling preferably within the range of 45°±3°, more preferably within the range of 45°±1°, still more preferably within the range of 45°±0.5°.

When the liquid crystal panel 100B includes the circular polarizer 53 in its front surface side, the transmittance can be suitably modulated. Thus, the display mode of the liquid crystal panel 100B is more preferably a vertical electric field mode such as the VA mode than a transverse electric field mode such as the IPS mode.

Examples of the configuration of the liquid crystal panel 100B include a configuration including a first substrate including a first electrode, a liquid crystal layer, and a second substrate including a second electrode in the stated order. The first substrate may be the TFT substrate 10 described in Embodiment 1. The first electrode may be a pixel electrode formed in the TFT substrate 10. The second substrate may be the CF substrate 20 described in Embodiment 1. The second electrode may be a counter electrode opposite to the pixel electrode.

In a VA mode liquid crystal panel, the liquid crystal molecules in the liquid crystal layer 30 preferably have a negative anisotropy of dielectric constant, and are preferably aligned substantially vertically to the TFT substrate 10 or the CF substrate 20 with no voltage applied to the liquid crystal layer 30.

When the liquid crystal molecules are aligned substantially vertically with no voltage applied, light emitted from the backlight 200 side (hereinafter, backlight illumination) is not transmitted toward the observer, so that the liquid crystal panel 100B is in the black display state. When voltage equal to or higher than the threshold of the liquid crystal molecules is applied between the pixel electrode and the counter electrode, the liquid crystal molecules tilt from the substantially vertical direction to transmit backlight illumination toward the observer, so that the liquid crystal panel 100B goes into the white display state.

### Embodiment 3

FIG. 7 is a schematic cross-sectional view showing an example of a display device according to Embodiment 3. As shown in FIG. 7, a display device 1-C according to Embodiment 3 uses a self-luminous panel 100C as the display panel.

The self-luminous panel 100C is a panel that includes light emitting elements inside and can emit light by itself, thus being capable of emitting light toward the observer without any external light source such as a backlight. The self-luminous panel 100C can be a known one, such as an organic light emitting diode (OLED) panel including OLEDs.

As shown in FIG. 7, the self-luminous panel 100C may include a light emitting layer 31. The configuration of the light emitting diode is not limited, and may be, for example, a stack of a cathode, a light emitting layer, and an anode arranged in the stated order. When the light emitting element is an OLED, the light emitting layer 31 may include a fluorescent material, a phosphorescent material, or another material as a light emitting material. An electron transport layer may be disposed between the cathode and the light emitting layer. A hole transport layer may be disposed between the light emitting layer and the anode.

Light emitting elements such as OLEDs may be arranged, for example, in a matrix pattern in the TFT substrate 10. In this case, light emitting elements may be disposed for the respective TFTs arranged at or near the intersections of the gate lines and the source lines (i.e., may be disposed in the respective pixels). The region in which the light emitting elements are disposed defines the display region.

The light emitting elements may include red light emitting elements, green light emitting elements, and blue light emitting elements. A black matrix 23 may be disposed to surround each light emitting element. When the display panel is a self-luminous panel, the black matrix 23 may be printed on the supporting substrate 21 or the supporting substrate 21 may be used to protect the light emitting elements. Yet, the supporting substrate 21 may not be disposed.

The self-luminous panel 100C preferably includes a circular polarizer in its front surface plate 110 side (front surface side) in order to reduce the internal reflectance. When the display panel is a self-luminous panel, display can be provided without a polarizer in the front surface side of the display panel. Yet, with the self-luminous panel 100C including the circular polarizer 53 in its front surface plate 110 side as shown in FIG. 5, the internal reflectance can be reduced. A self-luminous panel such as an OLED panel has a higher internal reflectance than a liquid crystal panel. Thus, preferably, the self-luminous panel 100C includes the circular polarizer 53 in its front surface plate 110 side especially when the device is used in a bright environment such as an outdoor environment.

When the display panel is a self-luminous panel, transmissive display can be provided in a state where display light used to display an image or the like is emitted from the self-luminous panel. Reflective display can be provided by creating a state where the self-luminous panel is off or the self-luminous panel is on without displaying any image or the like, and the luminance of the self-luminous panel is reduced to an extent that allows the observer to perceive the pattern or the like of the design layer with reflected light.

### Embodiment 4

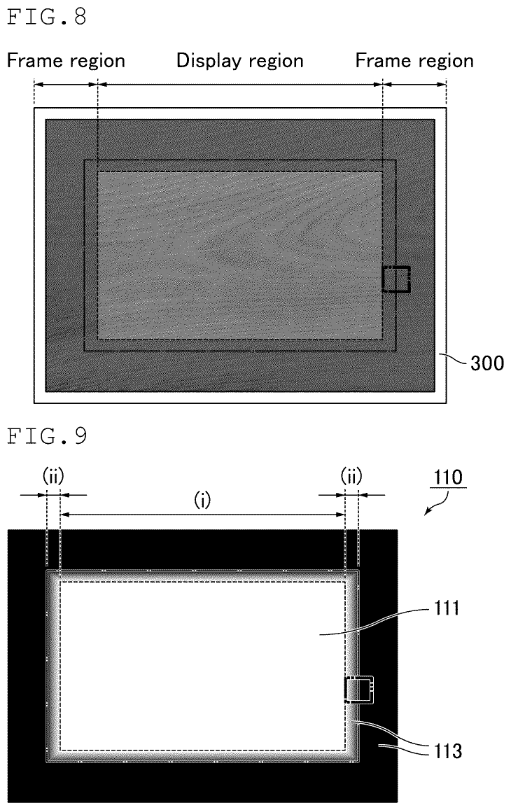

FIG. 8 is a schematic plan view of a display device, showing the boundary between the display region and the frame region of a liquid crystal panel superimposed with the outer edge of a black frame layer. FIG. 9 is a schematic plan view showing an example of a black frame layer included in a front surface plate in Embodiment 4. In FIG. 8 and FIG. 9, the dotted line indicates the boundary between the display region and the frame region of the display panel, and the dashed and dotted line indicates the inner side edge of the black frame layer 113 located toward the center of the display panel shown in FIG. 2.

Even in a state where the display panel is turned off, when the display device is observed from an oblique direction, the display region may appear slightly brighter than the frame region. In Embodiment 4, the reflectance of a region of the front surface plate overlapping the frame region of the display panel is adjusted, so that the boundary between the display region and the frame region can be made less noticeable even when the display device is observed from an oblique direction.

As shown in FIG. 9, in the display device according to Embodiment 4, the front surface plate 110 in a plan view includes: a first region (i) overlapping the display region of the display panel; and a second region (ii) surrounding the first region (i). The second region (ii) of the front surface plate 110 may partially overlap or may not coincide with the frame region of the display panel in the plan view.

The second region (ii) preferably has a reflectance of 6% or higher and 12% or lower. The first region (i) of the front surface plate 110 overlaps the display region of the display panel in a plan view, and the design layer 111 is disposed in the first region (i). When the design layer 111 includes a reflective pigment, the reflectance of the first region (i) of the front surface plate 110 is about 10% or higher in some cases. As shown in FIG. 2, the black frame layer 113 may be disposed in the region overlapping the frame region of the display panel, and the black frame layer 113 is normally a light blocking component and has a reflectance of approximately 0%. With the second region (ii) having a reflectance of 6% or higher and 12% or lower surrounding the first region (i) of the front surface plate 110, the boundary between the display region and the frame region can be made less noticeable even when the display device is observed from an oblique direction.

The reflectance of the first region (i) and the reflectance of the second region (ii) are preferably substantially the same. For example, the difference between the reflectance of the first region (i) and the reflectance of the second region (ii) is preferably 15% or less, more preferably 5% or less, still more preferably 3% or less.

The reflectance of the second region (ii) preferably becomes higher from the outer edge inside the display panel toward the first region (i). Specifically, in a plan view, the black frame layer 113 is preferably disposed in a region on the back surface side of the design layer 111 of the front surface plate 110 and overlapping the frame region of the display panel. Gradation printing may be performed in the second region (ii) such that the reflectance of the black frame layer 113 becomes higher toward the first region (i).

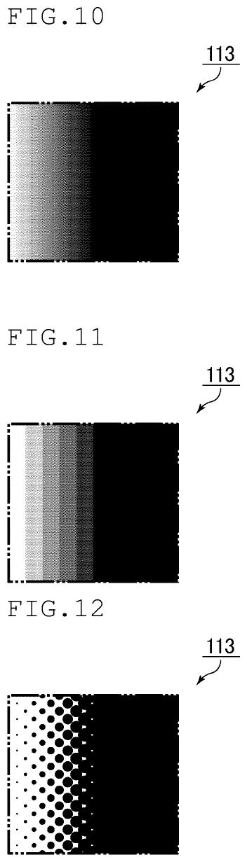

FIG. 10 to FIG. 12 are schematic plan views of first to third examples, respectively, with part of the second region in FIG. 9 being enlarged. FIG. 10 to FIG. 12 correspond to a portion surrounded by a dashed and double-dotted line in each of FIG. 8 and FIG. 9. As long as the reflectance of the black frame layer 113 can be made to become higher toward the first region (i), the method for performing gradation printing of the black frame layer 113 is not limited, and for example, any of the following methods may be used: as shown in FIG. 10, the shade of the black frame layer 113 is continuously changed; as shown in FIG. 11, the shade of the black frame layer 113 is changed stepwise; and, as shown in FIG. 12, the shade of the black frame layer 113 is changed by reducing areas of dots toward the first region (i).

### <Backlight Configuration>

The following describes a configuration of a display device including a liquid crystal panel as the display panel and further including a backlight behind the back surface side of the liquid crystal panel. The configuration uses the backlight configuration to make the boundary between the display region and the frame region less perceivable during transmissive display.

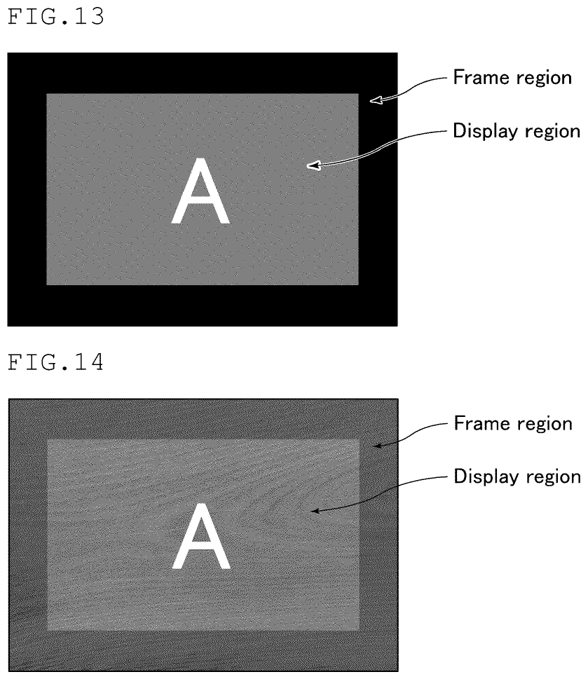

FIG. 13 and FIG. 14 are used to describe decreases in back level. FIG. 13 is a reference diagram of a display panel, illustrating a decrease in black level during transmissive display. FIG. 14 is a reference diagram of a display device with the display panel in FIG. 13 being overlaid with a front surface plate.

The display panel, when defined by a liquid crystal panel, may cause a decrease in black level while displaying a black image in the display region. FIG. 13 shows an example in which the letter A is displayed in white in the display region of the display panel while the background of the letter is displayed in black. Since a liquid crystal panel transmits a slight amount of backlight illumination even in the black display state, the black color in the display region appears slightly brighter than the perfect black color (causes a decrease in black level) in some cases. The decrease in black level is expressed by a product of the transmittance of the liquid crystal panel in the black display state and the luminance of the backlight. The specific values are given below. The transmittance of the liquid crystal panel in the black display state is usually about 0.006%. When the luminance of the backlight is assumed to be 10000 cd/m², then the decrease in black level is to be about 0.6 cd/m², which is enough to make a perceivable difference in the black color from that in the frame region. Even when a liquid crystal panel with such a decrease in black level is overlaid with the front surface plate as shown in FIG. 14, the boundary between the display region and the frame region would be undesirably perceived during transmissive display.

Preferably, when the backlight is turned on, the luminance of the fourth region (iv) overlapping the frame region of the liquid crystal panel is 50% or less of the luminance of the third region (iii) overlapping the display region of the liquid crystal panel. This configuration can make the boundary between the display region and the frame region less perceivable during transmissive display of the liquid crystal panel.

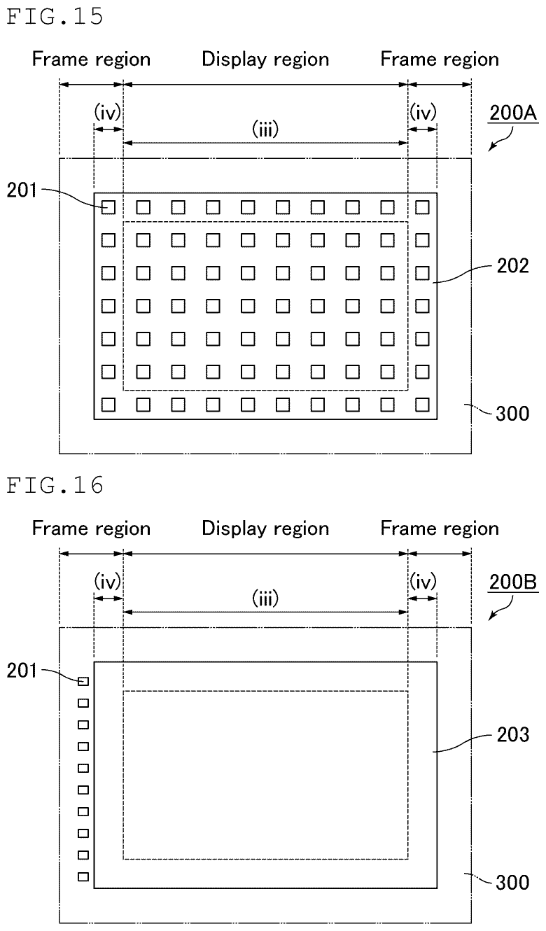

The backlight may be a direct-lit backlight or an edge-lit backlight. FIG. 15 is a schematic plan view showing an example of a direct-lit backlight. FIG. 16 is a schematic plan view showing an example of an edge-lit backlight. In FIG. 15 and FIG. 16, the positions of the display region and the frame region of the display panel are indicated by the dashed and double-dotted lines, for reference. As shown in FIG. 15 and FIG. 16, backlights 200A and 200B in a plan view include a third region (iii) overlapping the display region of the liquid crystal panel, and a fourth region (iv). In addition, the fourth region (iv) surrounds the third region (iii).

As shown in FIG. 15, the backlight may be a direct-lit backlight 200A in which light emitting elements 201 are arranged in a matrix pattern. The light emitting elements 201 may be arranged in an in-plane direction of the substrate 202. Although not shown, the backlight 200A may further include a diffusion film, for example. The substrate 202 is not limited and may be one known in the field of backlights.

Examples of the light emitting elements 201 include those known in the field of backlights, such as light emitting diodes (LEDs).

The backlight 200A further includes a luminance adjustment mechanism which adjusts the luminance of the backlight. The luminance adjustment mechanism preferably adjusts the light emission intensity of each of the light emitting elements 201 according to the displayed image on the liquid crystal panel 100A. The driving method including adjusting the light emission intensity of each of the light emitting elements 201 according to the displayed image on the liquid crystal panel 100A is also referred to as partial driving (local dimming).

The luminance adjustment mechanism preferably adjusts the luminance of the light emitting elements 201 arranged in the third region (iii) shown in FIG. 15 and the luminance of the light emitting elements 201 arranged in the fourth region (iv) such that the luminance of the fourth region of the backlight 200A is 50% or less of the luminance of the third region. Also, when the displayed image on the liquid crystal panel 100A is a black image, the light emitting elements 201 overlapping the region displaying the black image are turned off to reduce or prevent a decrease in black level.

As shown in FIG. 16, the backlight may be an edge-lit backlight 200B including a light guide plate 203 and light emitting elements 201 arranged on a side surface of the light guide plate 203. Although not shown, the backlight 200B may further include a reflective sheet and a diffusion film, for example.

The light guide plate 203 is not limited and can be one known in the field of backlights. The light guide plate 203 may be provided on its surface with irregularities, grooves, or embosses, for example, to emit light incident on its side surface from the light emitting elements 201 toward the observer.

As shown in FIG. 16, the reflectance of the region overlapping the fourth region (iv) of the light guide plate 203 is preferably lower than the reflectance of the region overlapping the third region (iii). Preferably, the reflectance of the region overlapping the fourth region (iv) is set lower than the reflectance of the region overlapping the third region (iii) to adjust the luminance of the fourth region of the backlight 200B to 50% or less of the luminance of the third region.

The reflectance of the light guide plate 203 can be adjusted by, for example, varying the density of the structures such as irregularities, grooves, or embosses. When the density of the structures formed in the region overlapping the fourth region (iv) is set lower than the density of the structures formed in the region overlapping the third region (iii), the reflectance of the region overlapping the fourth region (iv) can be made lower than the reflectance of the region overlapping the third region (iii).

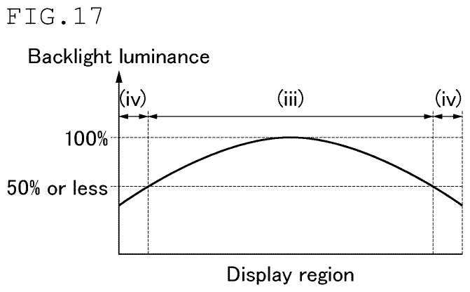

FIG. 17 is a graph showing an example of luminance of the third region (iii) and the fourth region (iv) in each of the backlights shown in FIG. 15 and FIG. 16. As shown in FIG. 17, the luminance of the central portion of the third region (iii) may be the highest and the luminance may decrease toward the outer edge of the fourth region (iv) (boundary between the fourth region (iv) and the frame region). In the boundary between the third region (iii) and the fourth region (iv), there may be no clear luminance boundary; the luminance preferably varies gently. When the maximum luminance of the third region (iii) is taken as 100%, the luminance of the boundary between the third region (iii) and the fourth region (iv) is preferably 50% or less of the maximum luminance.

### <Backlight Driving Method>

In a display device including a liquid crystal panel as the display panel and further including a backlight behind the back surface side of the liquid crystal panel, the difference in luminance between the display region and the frame region of the liquid crystal panel in the black display state under 500 to 1000 lux is preferably 5% or less.

When the luminance of the display region of the liquid crystal panel in the back display state in a bright room (500 to 1000 lux) and the luminance of the frame region in a bright room (500 to 1000 lux) are made substantially the same (difference of 5% or less), the boundary between the display region and the frame region of the liquid crystal panel can be made less perceivable. As shown in FIG. 2, when the black frame layer 113 is disposed on the back surface side of the design layer 111 in the front surface plate 110, the reflectance of the frame region overlapping the black frame layer 113 is about 6% to 12%.

The backlight is not limited and may be a direct-lit backlight or an edge-lit backlight. When the luminance of the display region of the liquid crystal panel in the black display state and the luminance of the frame region are made substantially the same, the boundary between the display region and the frame region of the liquid crystal panel can be made less perceivable even without the above-described backlight including regions with different luminance values.

Examples of a specific configuration producing a difference in luminance between the display region and the frame region of the liquid crystal panel in the black display state of 5% or less include the following configuration.

The display device may further include a luminance adjustment mechanism that adjusts the luminance of the backlight, and the luminance adjustment mechanism may control the backlight to be constantly turned on during reflective display in which light incident from observer side is reflected to allow the observer to perceive the pattern of the design layer. Even in a state where no desired image is displayed on the liquid crystal panel (state where the display panel is not used), keeping the backlight turned on allows the boundary between the display region and the frame region of the liquid crystal panel to be less perceivable.

In the configuration in which the backlight is constantly turned on during reflective display, the liquid crystal panel may be in the black display state (hereinafter, also referred to as a driving method A). In the configuration in which the backlight is constantly turned on during reflective display, the liquid crystal panel may be in a transmissive state (hereinafter, also referred to as a driving method B). From the viewpoint that the power consumption can be reduced, the driving method B (in a configuration in which the backlight is constantly turned on, the liquid crystal panel is in the transmissive state) is preferred.

The transmissive state of the driving method B is preferably a state where the luminance of the liquid crystal panel is the highest (full white state). In addition, in the driving method B, preferably, the liquid crystal panel is set in the full white state and the backlight is slightly turned on. The expression that “the backlight is slightly turned on” means that, for example, the luminance of the backlight is 5 to 10 cd/m², for example.

Specifically, when the contrast ratio of the liquid crystal panel is 1500 and the transmittance of the liquid crystal panel in the black display state is 5%, then the transmittance of the liquid crystal panel in the white display state is to be 1500×δ%. For example, the same brightness can be obtained by a driving method (driving method A) including making the liquid crystal panel in the black display state provide display with a transmittance of 5% while keeping the backlight turned on with 10,000 cd/m² and by a driving method (driving method B) including making the liquid crystal panel in the white display state provide display with a transmittance of 1500×5% while keeping the backlight turned on with 6.7 cd/m². In other words, the driving method B achieves the same effect (luminance) with about 1/1500 of the power consumption by the driving method A. The driving method B is particularly effective for devices such as smartphones driven by a battery, for example.

The luminance values of the driving method A and the driving method B can be calculated as follows using specific transmittances.
Driving method A: transmittance in black state 0.0067%×backlight luminance 10000 cd/m²=0.67 cd/m²
Driving method B: transmittance in full white state 10%×backlight luminance 6.7 cd/m²=0.67 cd/m²

In other words, the driving method A and the driving method B achieve the same luminance of the display device, but the power consumption (standby power consumption) by the driving method B is 1/1500 of the power consumption (standby power consumption) by the driving method A.

The display devices according to the embodiments, for example, may be used as an instrument panel of an automobile to display instruments such as a speedometer, or may be used as a control panel of a home electrical appliance.

### EXAMPLES

The effect of the present invention is described below based on examples and comparative examples. The present invention is not limited to these examples.

### Example 1

A display device 1 of Example 1 corresponds to a specific example of the display device 1 according to Embodiment 1 and has a configuration shown in FIG. 1 and FIG. 2. The display panel was a VA mode liquid crystal panel sandwiched between a pair of linear polarizers. The pair of linear polarizers was arranged with their transmission axes being orthogonal to each other.

As shown in FIG. 5, the transmittance of the design layer 111 is denoted as α and the internal reflectance of the liquid crystal panel is denoted as β. The internal reflectance of the liquid crystal panel is the reflectance between the TFT substrate 10 and the CF substrate 20 shown in FIG. 2 and excludes the reflectance of the first linear polarizer 51 in the front surface side.

When the luminance of light after emerging from the first linear polarizer 51 is denoted as the display panel luminance L2, the luminance of light L3 emitted toward the observer during transmissive display is expressed as L2×α as described above. The internal reflectance of the display device calculated using the internally reflected light L7 during reflective display is about α²×β as described above. In Example 1, the liquid crystal panel 100A and the front surface plate 110 are attached to each other with an optical adhesive layer 120 to be an integrated component, so that no interface reflection occurs between the liquid crystal panel 100A and the front surface plate 110.

### Comparative Example 1

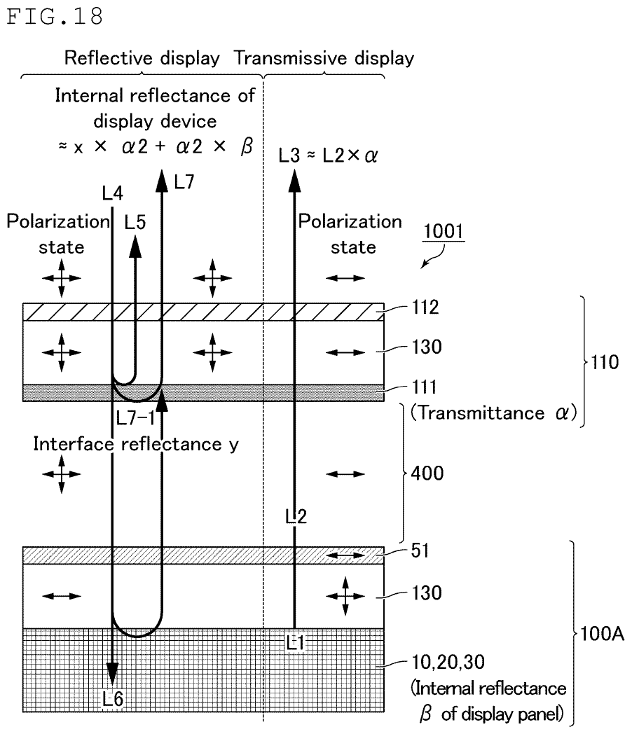

FIG. 18 is a schematic cross-sectional view illustrating part of the configuration of a display device according to Comparative Example 1 and a display method thereof. A display device 1001 of Comparative Example 1 has a configuration similar to that of Example 1, except that the liquid crystal panel 100A and the front surface plate 110 are not attached to each other with the optical adhesive layer 120 and an air layer 400 is present between the liquid crystal panel 100A and the front surface plate 110.

As shown in FIG. 18, the luminance of light L3 emitted toward the observer during transmissive display is expressed as L2×α, as in Example 1.

During reflective display, reflected light L5 derived from ambient light L4 reflected on the surface of the design layer 111 and light L6 absorbed inside the display panel are similar to those in Example 1, and thus description thereof is omitted. In Comparative Example 1, since the air layer 400 is present between the liquid crystal panel 100A and the front surface plate 110, part of ambient light L4 undergoes interface reflection at the boundary between the front surface plate 110 and the air layer 400 (L7-1). Meanwhile, part of ambient light L4 incident on the display panel is internally reflected by components defining the display panel, combined with the interface-reflected light L7-1, and emitted toward the observer (L7). When the interface reflectance is denoted as y, the internal reflectance of the display device of Comparative Example 1 is about y×α²+α²×β.

### Comparative Example 2

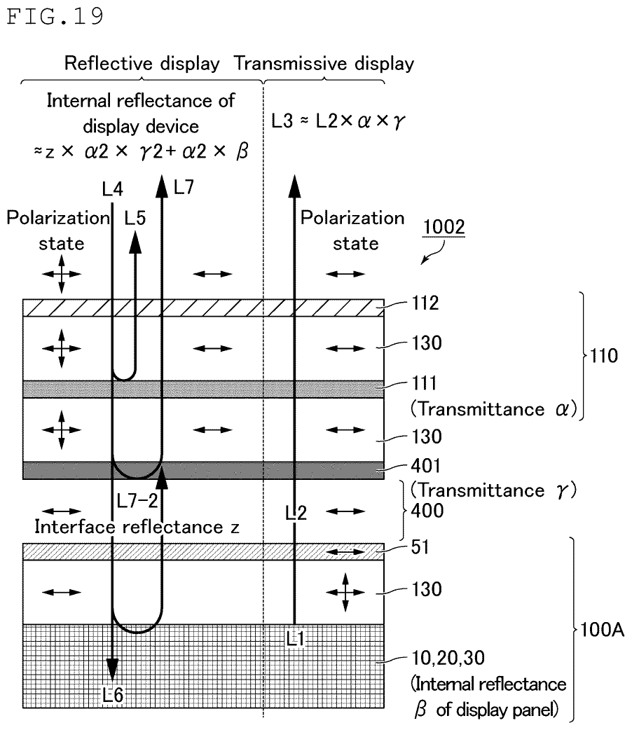

FIG. 19 is a schematic cross-sectional view illustrating part of the configuration of a display device according to Comparative Example 2 and a display method thereof. A display device 1002 of Comparative Example 2 has a configuration similar to that of Example 1, except that the liquid crystal panel 100A and the front surface plate 110 are not attached to each other with the optical adhesive layer 120 and the air layer 400 is present between the liquid crystal panel 100A and the front surface plate 110, and that a smoke layer 401 is disposed on the back surface side of the design layer 111.

The smoke layer 401 can be formed by, for example, applying a resin composition obtained by mixing a transparent resin with a black pigment to the back surface side of the front surface plate. The transmittance γ of the smoke layer 401 can be adjusted by adjusting the amount of the black pigment added and is, for example, 70% or lower.

As shown in FIG. 19, since the smoke layer 401 is disposed in Comparative Example 2, when the transmittance of the smoke layer 401 is denoted as γ %, the luminance of light L3 emitted toward the observer during transmissive display is expressed as L2×α×γ.

Reflected light L5 derived from ambient light L4 reflected on the surface of the design layer 111 and light L6 absorbed inside the display panel during reflective display are similar to those in Example 1, and thus description thereof is omitted. In Comparative Example 2, since the air layer 400 is present between the liquid crystal panel 100A and the front surface plate 110, part of ambient light L4 undergoes interface reflection at the boundary between the smoke layer 401 and the air layer 400 (L7-2). Meanwhile, part of the ambient light L4 incident on the display panel is internally reflected by the components defining the display panel, combined with the interface-reflected light 7-2, and emitted toward the observer (L7). When the interface reflectance is denoted as z, the internal reflectance of the display device of Comparative Example 2 is about z×α²×γ²+α²×β.

The luminance of light L3 emitted toward the observer during transmissive display and the internal reflectance of the display device during reflective display in each of Example 1 and Comparative Examples 1 and 2 were calculated assuming that α=70%, β=1.5%, and γ=70%. The following Table 1 shows the results. The values α, β, and γ can be measured using a spectrophotometer CM-5 available from Konica Minolta, Inc.

TABLE 1

| | Internal reflectance | | Luminance of light L3 emitted | |
|---|---|---|---|---|
| | of display device | | toward observer during | |
| | during reflective display | | transmissive display | |
| Example 1 | α² × β | 0.70% | L2 × α | α = 70% |
| Comparative | y × α² + | 2.70% | L2 × α | α = 70% |
| Example 1 | α² × β | | | |
| Comaprative | z × α² × γ² + | 1.70% | L2 × α × γ | α × γ = 49% |
| Example 2 | α² × β | | | |

As shown in Table 1, since the internal reflectance of the display device was as low as 0.7% in Example 1, the pattern of the design layer during reflective display appeared vivid, not whitish. Also, since the luminance of L3 was high, display was successfully provided without the displayed image appearing dark during transmissive display.

In contrast, since the internal reflectance of the display device was as high as 2.7% in Comparative Example 1, ambient light was more reflected than in Example 1, so that the pattern of the design layer appeared whitish. In Comparative Example 2, reflection of ambient light was reduced as compared to that in Comparative Example 1, but the luminance of L3 was 49%, which led to dark displayed images during transmissive display.

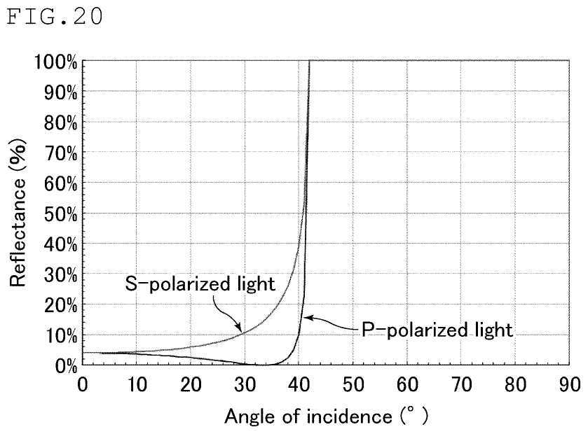

FIG. 20 is a graph showing the interface reflectance when light enters a medium with a refractive index of 1 from a medium with a refractive index of 1.5. The interface reflectance is derived from the Fresnel reflection equation which is a function according to the refractive index of the medium and the angle of incidence on the medium. FIG. 20 shows an example in which the direction normal to the medium such as the substrate is set at 0° and the interface reflectance at an angle of incidence of light of 0° is 4%. Although the angle of incidence at which total reflection occurs is different between P-polarized light and S-polarized light, the interface reflectance increases as the angle of incidence increases. In other words, in observation from an oblique direction, the difference in interface reflectance between the display device of Example 1 and the display devices of Comparative Examples 2 and 3 is larger than that in observation from the normal direction.

### Example 2

Example 2 is a specific example of Embodiment 2. The display panel was a VA mode liquid crystal panel. The liquid crystal panel included a circular polarizer 53 in the front surface side and a circular polarizer 54 in the back surface side. As shown in FIG. 5, the display device of Example 2 has a configuration similar to that of Example 1, except that the polarizers in the front surface side and the back surface side of the liquid crystal panel are circular polarizers.

### Comparative Example 3

Comparative Example 3 differs from Example 2 in that the liquid crystal panel and the front surface plate are not attached to each other with the optical adhesive layer and the air layer is present between the liquid crystal panel and the front surface plate. As shown in FIG. 18, the display device of Comparative Example 3 has a configuration similar to that of Comparative Example 1, except that the first linear polarizer 51 in the front surface side of the liquid crystal panel was replaced by a circular polarizer.

### Comparative Example 4

Comparative Example 4 differs from Example 2 in that the liquid crystal panel and the front surface plate are not attached to each other with the optical adhesive layer and the air layer is present between the liquid crystal panel and the front surface plate, and that the smoke layer is disposed on the back surface side of the design layer. As shown in FIG. 19, the display device of Comparative Example 4 has a configuration similar to that of Comparative Example 2, except that the first linear polarizer 51 in the front surface side of the liquid crystal panel was replaced by a circular polarizer.

Since a circular polarizer was used in each of Example 2 and Comparative Examples 3 and 4, the internal reflectance β of the liquid crystal panel was β=0.5%, which was lower than that in Example 1. The luminance of light L3 emitted toward the observer during transmissive display and the internal reflectance of the display device during reflective display in each of Example 2 and Comparative Examples 3 and 4 were calculated assuming that α=70%, β=0.5%, and γ=70%. The following Table 2 shows the results.

TABLE 2

| | Internal reflectance | | Luminance of light L3 emitted | |
|---|---|---|---|---|
| | of display device | | toward observer during | |
| | during reflective display | | transmissive display | |
| Example 2 | α² × β | 0.20% | L2 × α | α = 70% |
| Comparative | y × α² + | 2.20% | L2 × α | α = 70% |
| Example 3 | α² × β | | | |
| Comparative | z × α² × γ² + | 1.20% | L2 × α × γ | α × γ = 49% |
| Example 4 | α² × β | | | |

The internal reflectance of the display device during reflective display of Example 2 was 0.2%, which led to even more vivid reflective display than in Example 1.

### Example 3

Example 3 is a specific example of Embodiment 3. A display device of Example 3 has a configuration similar to that of Example 1, except that as shown in FIG. 5, the display panel is an LED panel, and the LED panel includes no polarizer in the back surface side and includes the circular polarizer 53 in the front surface side.

### Comparative Example 5

Comparative Example 5 differs from Example 3 in that the LED panel and the front surface plate are not attached to each other with the optical adhesive layer and the air layer is present between the LED panel and the front surface plate. As shown in FIG. 18, the display device of Comparative Example 5 has a configuration similar to that of Comparative Example 1, except that the display panel is an LED panel and the LED panel includes no polarizer in the back surface side and includes the circular polarizer 53 in the front surface side.

### Comparative Example 6

Comparative Example 6 differs from Example 3 in that the LED panel and the front surface plate are not attached to each other with the optical adhesive layer and the air layer is present between the LED panel and the front surface plate, and that the smoke layer is disposed on the back surface side of the design layer. As shown in FIG. 19, the display device of Comparative Example 6 has a configuration similar to that of Comparative Example 2, except that the display panel is an LED panel and the LED panel includes no polarizer in the back surface side and includes the circular polarizer 53 in the front surface side.

Since a circular polarizer was used in each of Example 3 and Comparative Examples 5 and 6, the internal reflectance β of the liquid crystal panel was β=0.5%, which was lower than that in Example 1. The luminance of light L3 emitted toward the observer during transmissive display and the internal reflectance of the display device during reflective display in each of Example 3 and Comparative Examples 5 and 6 were calculated assuming that α=70%, β=0.5%, and γ=70%. The following Table 3 shows the results.

TABLE 3

| | Internal reflectance | | Luminance of light L3 emitted | |
|---|---|---|---|---|
| | of display device | | toward observer during | |
| | during reflective display | | transmissive display | |
| Example 3 | α² × β | 0.20% | L2 × α | α = 70% |
| Comparative | y × α² + | 2.20% | L2 × α | α = 70% |
| Example 5 | α² × β | | | |
| Comparative | z × α² × γ² + | 1.20% | L2 × α × γ | α × γ = 49% |
| Example 6 | α² × β | | | |

The display device of Example 3 exhibited an internal reflectance equivalent to that in Example 2 owing to the circular polarizer disposed in the front surface side even when the display panel was an LED panel, and thereby provided more vivid reflective display than that of Example 1.

### REFERENCE SIGNS LIST

1-A, 1-B, 1-C, 1001, 1002: display device
10: first substrate (TFT substrate)
20: second substrate (CF substrate)
21: supporting substrate
22: color filter layer
23: black matrix
30: liquid crystal layer
31: light emitting layer
40: sealing material
51: first linear polarizer
52: second linear polarizer
53, 54: circular polarizer
100: display panel
100A, 100B: display panel (liquid crystal panel)
100C: display panel (self-luminous panel)
110: front surface plate
111: design layer
112: transparent component
113: black frame layer
114: planarization layer
120: optical adhesive layer
130: adhesive layer
200: backlight
200A: direct-lit backlight
200B: edge-lit backlight
201: light emitting element
202: substrate
203: light guide plate
300: casing
301: double-sided tape
302: black layer
400: air layer
401: smoke layer

What is claimed is:

1. A display device comprising:
a display panel; and
a front surface plate disposed closer to an observer side than the display panel is,
the display panel in a plan view including a display region and a frame region surrounding the display region,
the front surface plate in a plan view including a design layer that overlaps the display region, the front surface plate transmitting at least part of light incident from the display panel and reflecting at least part of light incident from the observer side,
a transmittance of a region of the front surface plate overlapping the display region being 50% or higher,
the front surface plate and the display panel being attached to each other with an optical adhesive layer,
a refractive index of the optical adhesive layer being 1.4 or higher and 1.6 or lower.

2. The display device according to claim 1,
wherein the display panel includes a circular polarizer in its front surface plate side.

3. The display device according to claim 2,
wherein the display panel is a liquid crystal panel, and
the liquid crystal panel includes a first substrate including a first electrode, a liquid crystal layer, and a second substrate including a second electrode in the stated order.

4. The display device according to claim 2,
wherein the display panel is a self-luminous panel.

5. The display device according to claim 1,
wherein the front surface plate in a plan view includes a first region overlapping the display region of the display panel and a second region surrounding the first region, and
a reflectance of the second region is 6% or higher and 12% or lower.
